(19) United States
(12) Patent Application Publication
(10) Pub. No.: US 2006/0151130 A1
(43) Pub. Date: Jul. 13, 2006

(54) Mounting system for end vanes in vertical vane blind

(75) Inventor: Bogdan R. Ulatowski, Westminster, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Hunter Douglas Inc., Upper Saddle River, NJ (US)

(21) Appl. No.: 11/316,074

(22) Filed: Dec. 22, 2005

Related U.S. Application Data
(60) Provisional application No. 60/642,186, filed on Jan. 7, 2005.

(51) Int. Cl. E06B 9/36

(52) U.S. Cl. 160/168.1 V

(57) ABSTRACT

A system for connecting fixed and movable end vanes in a vertical vane covering for architectural openings is disclosed wherein the covering includes a plurality of vertically suspended vanes interconnected by face sheet material which is extendable around opposite ends of the covering through fixed end vanes at one end of the covering and movable end vanes at the opposite end of the covering. The fixed and movable end vanes are pivotally mounted to be positioned through forces applied thereto by the face sheet material so that the ends of the covering are covered by the first and second fixed and movable end vanes in an aesthetically pleasing manner.

### CROSS-REFERENCE TO RELATED APPLICATION

This application claims the benefit of U.S. provisional application No. 60/642,186, filed 07 Jan. 2005, of which is hereby incorporated by reference as if fully disclosed herein.

### BACKGROUND OF THE INVENTION

1. Field of the Invention

This invention relates generally to vertical vane blinds and more particularly to systems for mounting the endmost vanes in the blind for proper positioning in extended and retracted positions of the blind.

2. Description of the Relevant Art

Coverings for architectural openings such as doors, windows, archways, and the like have been known in various forms for many years. One form of such covering is commonly referred to as a vertical vane covering wherein a control system suspends and is operable to selectively manipulate a plurality of vertically suspended vanes such that the vanes can be moved laterally across the architectural opening to extend or retract the covering and pivoted about longitudinal vertical axes to open and close the vanes.

Control systems for operating vertical vane coverings typically include a headrail in which a plurality of carriers associated with each vane are movably mounted for lateral movement and include internal mechanisms for pivoting the vanes about their vertical axes. The headrails vary in construction and configuration to house the various types of carriers but typically the headrails are relatively large in cross-section to enclose the working components of the system and have a slot along a bottom or side wall through which a portion of each carrier protrudes for connection to an associated vane.

Control systems are typically operated from one side of the covering either manually or with an electric motor with the control end of the headrail having a primary end cap in which pull cords, an electric motor or the like, is housed for reciprocally moving the carriers laterally of the architectural opening along the length of the headrail. In some coverings, the vertically suspended vanes are interconnected with a face sheet material that simulates a curtain in that loops of the face sheet material extend between adjacent vanes for desirable aesthetics. The face sheet material is typically connected along one edge to the primary end cap in an aesthetically attractive manner. The opposite edge of the face sheet material is typically operably connected to the endmost carrier spaced the greatest distance from the primary end cap. The endmost carrier is movable along the length of the headrail to the far end of the headrail where a secondary end cap encloses the far end of the headrail. In some coverings of the type disclosed in U.S. Pat. No. 6,076,588, which is of common ownership with the present application, the endmost carrier has operably connected thereto a pivot arm that swings around the secondary end cap when the covering is fully extended to provide an aesthetically pleasing closure to the associated end of the headrail.

It is to provide an alternative system for mounting the endmost vanes at the primary and secondary ends of the headrail that the present invention has been developed.

### SUMMARY OF THE INVENTION

The present invention is a system for mounting fixed and movable end vanes in a vertical vane covering system wherein a face sheet material interconnects a plurality of vertically suspended main vanes and fixed and movable end vanes which are connected to the primary and secondary end caps of the covering to provide an aesthetically pleasing closure at both ends of the covering. The primary end cap functions as the housing for a control system for moving the main vanes between extended and retracted positions and further serves to support first and second fixed end vanes with the second fixed end vane being formed at a first vertical edge of the face sheet material and the first fixed end vane being formed at an intermediate location between the second fixed end vane and the closest main vane. At least the first fixed end vane is pivotally mounted to follow movement of the face sheet material when the vanes in the face sheet material are moved between open and closed positions. The second fixed end vane while being pivotally mounted is inhibited from substantial pivotal movement so as to remain in a substantially fixed position regardless of the open or closed positions of the main vanes.

The most remote main vane from the primary end cap is supported in a carrier that also supports a pivot arm with the pivot arm in turn operatively and pivotally supporting first and second movable end vanes. The second movable end vane is formed at a second vertical edge of the face sheet material while the first movable end vane is formed at an intermediate location between the second movable end vane and the closest main vane.

The pivotal mounting of the first and second fixed and movable vanes are unbiased so that the vanes follow the general movement of the face sheet material as the covering is extended and retracted and/or moved between open and closed positions. The second fixed and movable end vanes are both formed by looping the face sheet material about the associated edge of the face sheet material to establish a loosely looped end of the face sheet material which is secured to itself.

Other aspects, features, and details of the present invention can be more completely understood by reference to the following detailed description of a preferred embodiment, taken in conjunction with the drawings, and from the appended claims.

### BRIEF DESCRIPTION OF THE DRAWINGS

FIG. 1 is a fragmentary isometric looking downwardly on the open top of a headrail for a vertical blind covering system in accordance with the present invention with portions of the headrail having been removed for illustrative purposes.

FIG. 2 is an isometric looking downwardly on the covering of FIG. 1 with portions of the covering having been removed for clarity and with headrail components removed from FIG. 1 being illustrated and with the covering in a retracted/open position.

FIG. 3 is a top plan view similar to FIG. 2 with the covering in an extended/closed position.

FIG. 4 is an isometric looking at the primary end cap of the covering of FIGS. 1-3 with the first and second fixed end vane mounting systems being illustrated.

FIG. 5 is an isometric of a stop member mounted on a mounting plate for the second fixed end vane to inhibit pivotal movement of the second fixed end vane.

FIG. 6 is an enlarged fragmentary horizontal section taken along line 6-6 of FIG. 4.

FIG. 7 is an exploded fragmentary isometric similar to FIG. 4.

FIG. 8 is an exploded isometric of the components utilized for mounting the first and second movable end vanes of the covering of FIGS. 1-3.

FIG. 9 is a fragmentary isometric similar to FIG. 7 wherein the end cap mounts an electric motor for driving the control system rather than the manually operated system shown in FIG. 7.

### DESCRIPTION OF THE PREFERRED EMBODIMENT

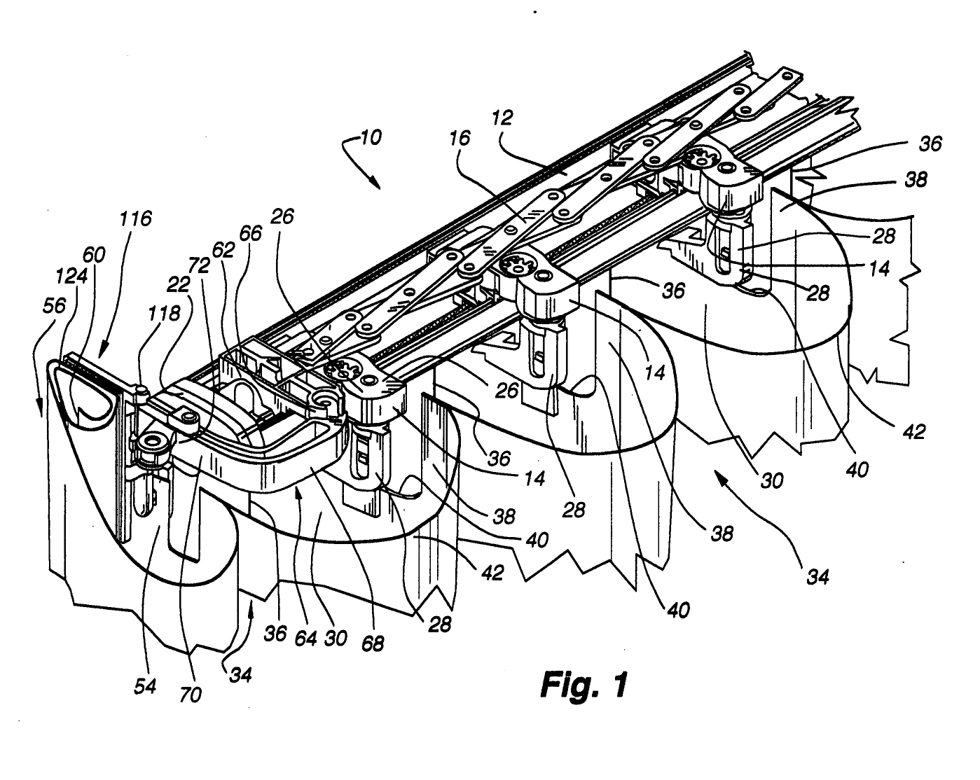

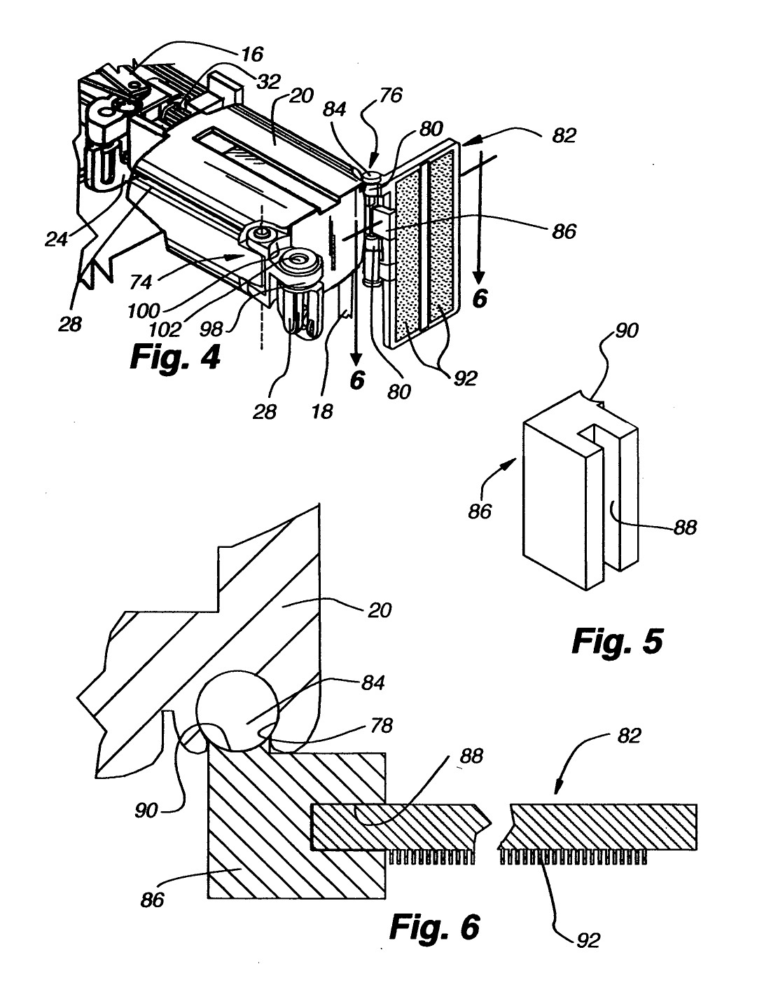

With reference first to FIGS. 1-3, a vertical blind type covering 10 for an architectural opening is illustrated having a headrail 12 that includes a plurality of carriers 14 suspended from a scissors-type system 16 and movable along the length of the headrail transversely of the architectural opening in which it is mounted by control cords 18 (FIG. 4). The control cords extend along the length of the headrail in a conventional manner and are interconnected with the carriers in a manner described in U.S. Pat. No. 6,076,588 which is of common ownership with the present application and the disclosure of which is hereby incorporated by reference. The control cords depend from a primary end cap 20 and are suspended along one edge of the covering for manipulation by an operator of the blind. Alternatively, and as will be described later, the manually operated system could be replaced by an electric motor system. The opposite end of the headrail from the primary end cap includes a secondary end cap 22 with the end caps providing closure to the open ends of the extruded headrail 12. Each carrier from the carrier 24 closest to the primary end cap to the most distant carrier 26 from the primary end cap, which is closest to the secondary end cap, have pivotally mounted hanger pins 28 adapted to support the upper edge of an associated main vane 30 with the hangers being pivotal by a tilt rod 32 (FIG. 4) that is horizontally disposed within the headrail and rotatable about its longitudinal axis in a conventional manner to operatively pivot the hanger pins and the vanes suspended therefrom.

While the main vanes 30 could take numerous configurations known in the art, in the illustrated embodiment, the vanes are formed from a sheet of material 34 that is vertically creased at intermittent locations 36 so as to be folded onto itself and secured together along a securement line 38 at locations spaced from but parallel with the creases. The sheet material can be adhesively bonded together from the crease 36 to the securement location 38 or left as a hollow pocket depending upon the desired appearance. Each vane formed from the sheet material folded upon itself is notched at 40 along an upper edge to accommodate the hanger pin 28 and to define an edge along which the hanger pin can be secured to the vane. The sheet material extends in a loop 42 from one vane to an adjacent vane with the looped material being referred to as face sheet material which thereby interconnects adjacent vanes. While the vanes could be made independently of the face sheet material 42 and simply secured thereto along one edge, in the disclosed embodiment, the sheet material 34 is continuous so as to define the vanes as well as the face sheet material 42 which is looped like a curtain from the side of the covering facing the interior of the architectural structure in which the covering is mounted. The sheet material could be any suitable material, but sheer fabrics have been found suitable.

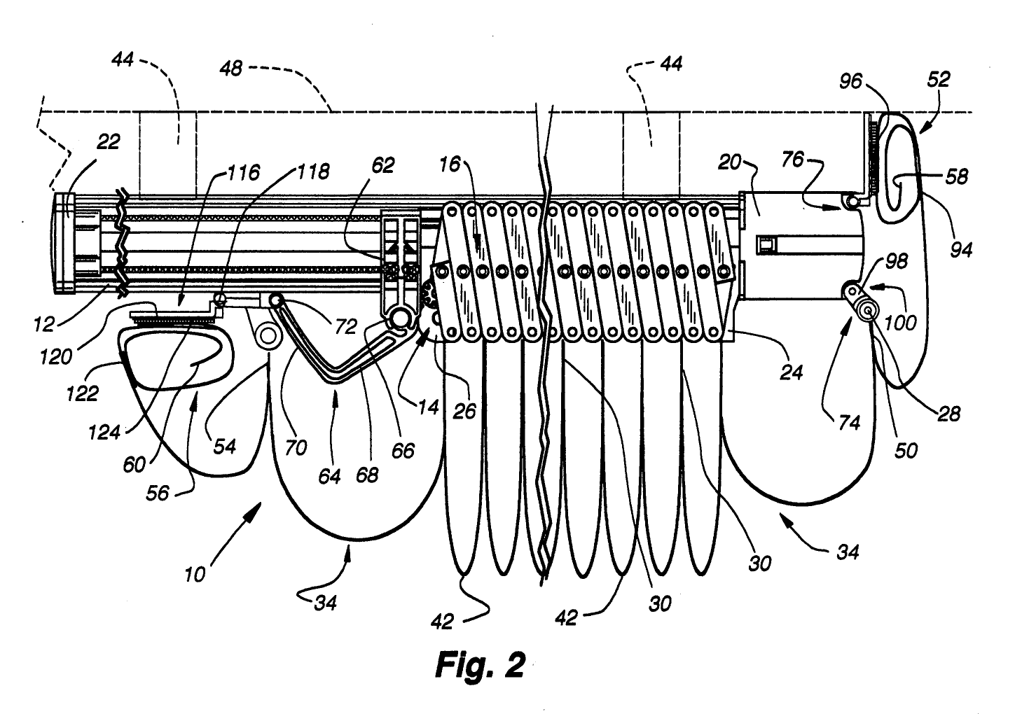

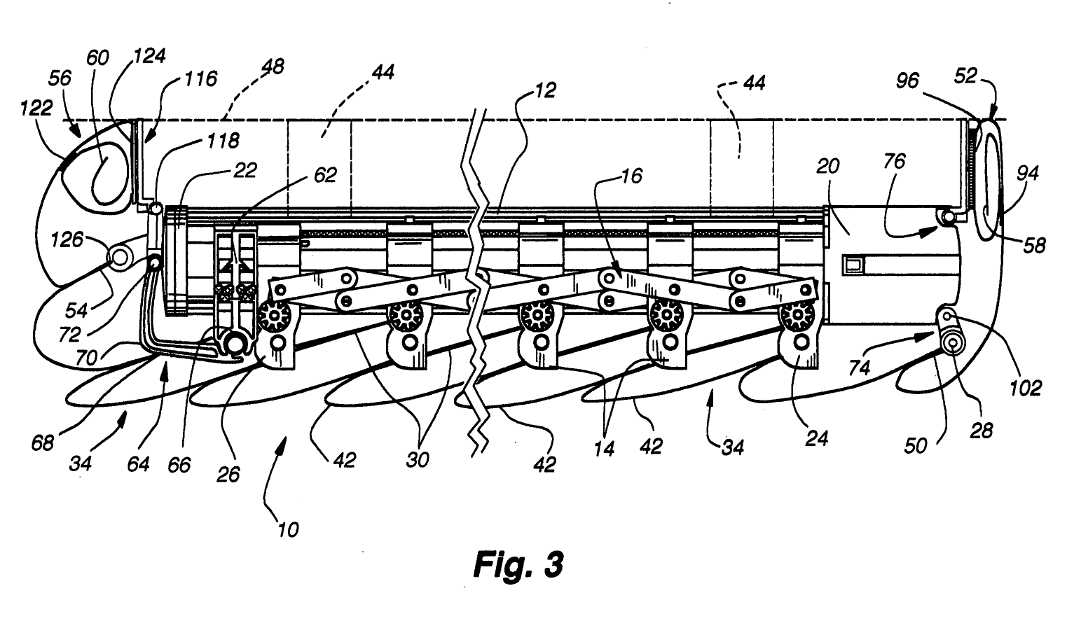

With reference to FIGS. 2 and 3, the headrail 12 is shown suspended from mounting brackets 44 secured to a wall 48 in the architectural structure in spaced relationship therefrom. As will be appreciated with the description that follows, fixed 50 and 52 and movable 54 and 56 endmost vanes defined at opposite vertical edges 58 and 60, respectively, of the sheet material 34 are mounted so as to close the gap between the headrail and the supporting wall for aesthetic purposes.

As described in more detail in the aforenoted U.S. Pat. No. 6,076,588, a mounting block 62 is secured to the carrier 26 most distant from the primary end cap 20 or closest to the secondary end cap 22 with the mounting block supporting a generally J-shaped pivot arm 64. The pivot arm is pivotally supported in a C-shaped groove 66 in the mounting block and a coil spring, not shown, is conventionally disposed at the pivotal interconnection of the pivot arm with the mounting block to bias the pivot arm in a clockwise direction as viewed in FIGS. 1-3. The pivot arm has a base leg 68 and an end leg 70 with the base leg being pivotally connected to the mounting block and the end leg having a vertically oriented C-shaped groove 72 formed in the distal end thereof defining a pivot location at the distal end of the end leg.

When the covering is moved between the extended position of FIG. 3 and the retracted position of FIG. 2, the distal end of the end leg 70 rides along the front face of the headrail 12 but when the pivot leg reaches the secondary end cap 22 as shown in FIG. 3, the coil spring urges the pivot arm to pivot in a clockwise direction so that the end leg swings around and rides along the end of the secondary end cap.

As mentioned previously, each end of the sheet material 34 has first and second end vanes formed therein to obtain desired aesthetics for the covering in both extended and retracted positions of the covering. The aesthetics are maintained between open and closed positions of the main vanes 30 with the open position of the main vanes being illustrated in FIG. 2 wherein the vanes are oriented generally perpendicularly to the headrail 12 and the closed position of FIG. 3 wherein the vanes lie in a substantially parallel relationship with the headrail.

With reference to FIGS. 4-7, the primary end cap 20 for the covering having the control cords 18 depending therefrom is illustrated. The primary end cap has a first pivotal mounting 74 for the first fixed end vane 50 and a second pivotal mounting 76 for the second fixed end vane 52. The second pivotal mounting is adjacent the rear edge of the primary end cap and as can be seen has a generally C-shaped groove 78 formed thereon that is straddled by C-shaped grooves 80 along the edge of a mounting plate 82. A pivot pin 84 extends through the grooves 78 and 80 when they are vertically aligned to establish a pivotal mounting of the mounting plate off the rear edge of the primary end cap. An abutment stop 86 shown in FIGS. 4, 5, and 6 has a groove 88 to receive one edge of the mounting plate so as to be connectable to the mounting plate and a second perpendicular edge 90 adapted to engage the C-shaped groove 78 on the primary end cap and the pivot pin 84 extending therethrough. The abutment stop 86 thereby inhibits pivotal movement of the mounting plate in a clockwise direction as viewed in FIGS. 4 and 6 in that attempted movement of the mounting plate in a clockwise direction causes the abutment stop to engage the C-shaped groove 78 on the primary end cap and prevent further pivotal movement beyond a position wherein the mounting plate 82 is perpendicular to the headrail. The mounting plate can pivot a small distance in a counterclockwise direction as may be desired when the covering is fully retracted and particularly when a motor driven system is used as will be described later.

The outer face of the mounting plate 82 has strips 92 of a hook-and-loop type releasable fastener such as Velcro® secured thereto which are adapted to releasably connect the mounting plate with the second fixed end vane 52. Other releasable fasteners could also be used such as appropriate adhesives. With reference to FIGS. 2 and 3, the second fixed end vane is defined by the sheet material 34 being looped about itself through two complete loops and secured to itself at a location 94 where the loops begin and overlap. An area opposite the location where the loops are connected together carries the second half 96 of the Velcro® connection material so that this location on the looped face sheet material can be releasably connected to the outer face of the mounting plate 82. The loosely looped face sheet material defines the second fixed end vane but the dual looping of the material prevents the fabric in the sheet material from flaring along its vertical length to provide desired uniform aesthetics.

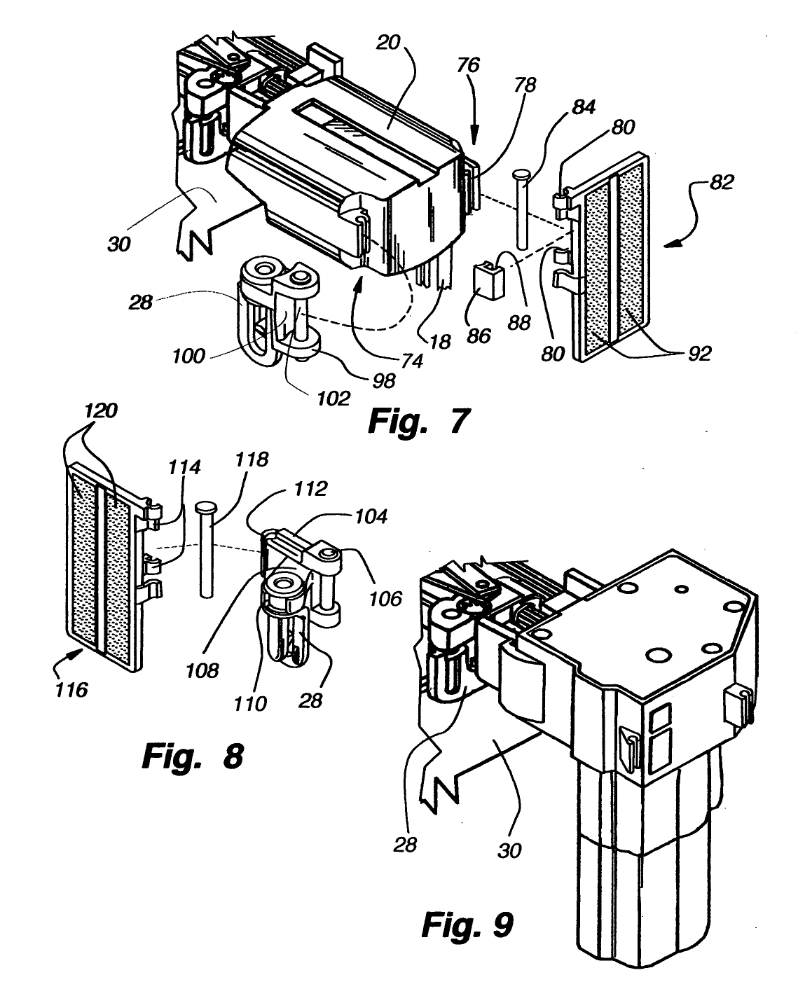

At an intermediate location between the second fixed endmost vane 52 and the closest carrier 24 of the covering, the first fixed end vane 50 is formed by creasing the sheet material 34 and folding it upon itself and securing the overlapping material to each other. The area where the material is secured to itself defines the first endmost vane and it is suspended from a hanger pin 28 identical to those described in connection with the main vanes 30 with the hanger pin being pivotally mounted on horizontal arms 98 of a yoke base 100 at the first pivotal mounting 74. The yoke base is pivotally connected to an edge of the primary end cap 20 with a vertical pivot pin 102 as probably best illustrated in FIGS. 4 and 7.

It will be appreciated from the above that the pivotal mountings of both the first 50 and second 52 fixed endmost vanes are unbiased, that is free to pivot in response to movement of the loops of face sheet material 42 which is caused when the covering is moved between extended and retracted positions or between open and closed positions of the main vanes. FIG. 2, for example, illustrates the position of the first and second fixed endmost vanes when the main vanes are open and the covering is fully retracted. When the vanes are closed, however, and the covering is fully extended, the first and second fixed end vanes assume the position shown in FIG. 3 wherein it will be appreciated the first fixed end vane has been pivoted clockwise relative to its position in FIG. 2, and the second fixed end vane has become slightly compressed relative to its position in FIG. 2. As mentioned, the movement of the fixed end vanes is responsive to the movement of the face sheet material as the covering is moved between its various positions so that the positioning of the fixed end vanes is not artificial but naturally follows from movement of the main vanes thereby giving an aesthetically pleasing and continuous appearance to the face sheet material.

As mentioned previously, the pivot arm 64 connected to the most distal carrier 26 operatively and pivotally supports the first 54 and second 56 movable end vanes. With reference to FIG. 8, a pivot plate 104 having a bifurcated end and a vertical pivot pin 106 is connected as probably best seen in FIGS. 1-3 to the C-shaped groove 72 at the end of the end leg 70 of the pivot arm so that the pivot plate freely pivots about the pivot pin under no bias. A horizontal arm 108 having a C-shaped groove 110 at its distal end extends away from the pivot plate 104 and pivotally supports a hanger pin 28 which is also free to pivot under no bias relative to the arm. The hanger pin, as will be described later, supports the first movable end vane 54 so that it can pivot freely with movement of the face sheet material 42. The free end of the pivot plate 104 has a C-shaped groove 112 adapted to be inserted between a pair of arms 114 along one edge of a second mounting plate 116 with each of the arms 114 having a C-shaped groove whereby when the C-shaped grooves on the mounting plate and the pivot plate are in vertical alignment, a pivot pin 118 can be inserted to establish a free unbiased pivotal relationship between the second mounting plate and the pivot plate 104. The second mounting plate has a releasable fastener such as Velcro® 120 on an outer face adapted to be releasably connected to the second movable end vane 56 as will be described hereafter.

The second movable end vane 56 is formed identically to the second fixed end vane 52 by looping the edge of the sheet material 34 about itself through two complete loops and securing the loop material to itself at the commencement location 122 of the two loops with an adhesive material. The opposite side of the first loop of material from the adhesive connection has the second half 124 of the Velcro® connection material thereon so it can be releasably interfaced with the Velcro® material 120 on the second mounting plate. The loosely looped face sheet material between the adhesive connection location and the Velcro® material defines the second movable end vane which moves in a manner to be described hereafter in response to movement of the covering.

The first movable end vane 54 is formed by creasing the face sheet material at a location 126 intermediate the second movable end vane 56 and the closest carrier 26 and securing the sheet material to itself, for example, with a suitable adhesive or the like. The material secured to itself forms the first movable end vane which can therefore be seen to be interconnected with the face sheet material 42 extending between the closest carrier 26 and the second movable end vane 56. With the movable end vanes mounted as described, when the covering is retracted as shown in FIG. 2, the free end of the end leg 70 of the pivot arm 64 as well as the pivot plate 104 pivotally connected thereto ride along the front face of the headrail 12 as shown in FIG. 2. However, when the covering is extended to its fully extended position of FIG. 3, as mentioned previously, the pivot arm swings around the secondary end cap 22 under the bias of the coil spring (not seen) with the pivot plate again forming a longitudinal extension from the end leg of the pivot arm so that the mounting plate for the second movable end vane is disposed perpendicularly to the headrail so as to cover the gap between the headrail and the wall on which it is mounted. The pivotal mounting of the first movable end vane facilitates free pivoting movement of the first movable end vane in response to encouragement from the face sheet material so that the movable end vanes move in response to the face sheet material to establish a continuous and desired aesthetic.

As is known in the art, the sheet material 34, which could desirably be a sheer material, can be made of any desired softness or rigidity through the use of resins or the like and of course the flexibility of the sheet material has a bearing on movement of the sheet material at opposite ends of the covering through its connection to the pivoted first and second fixed and movable end vanes. Also, as mentioned previously, the vanes themselves can be formed in any manner but are interconnected along outer edges to the sheet material, which at these locations define the face sheet material, either as an integral extension from the vane, as in the embodiment described, or as a connected extension from the vane if the vanes were made from a different material than the face sheet material.

As mentioned previously, the covering can be motor driven as opposed to being manually driven with control cords. As seen in FIG. 9, if the covering were motor driven, an alternative primary end cap would be used suitable for conventional interconnection with an electric motor. Like the primary end cap described previously, the alternative primary end cap has mountings with C-shaped grooves for pivotal connection to the first and second fixed end vanes. A description of the mounting of the first and second fixed end vanes to the alternative primary end cap will not be made as it would be repetitive.

Although the present invention has been described with a certain degree of particularity, it is understood that the present disclosure has been made by way of example, and changes in detail or structure may be made without departing from the spirit of the invention as defined in the appended claims.

1. The combination of a primary end cap and a vertical blind having a headrail, a plurality of vertically suspended main vanes and first and second fixed end vanes, a control system for moving said main vanes along said headrail, a face sheet material interconnecting said main vanes and said first and second fixed end vanes, and pivotal mounting systems on said primary end cap independently mounting said first and second fixed end vanes for pivotal movement about vertical axes.

2. The combination of claim 1 wherein said pivotal mounting systems are unbiased.

3. The combination of claim 2 wherein said mounting system for said second fixed end vane includes a mounting plate securable to said face sheet material.

4. The combination of claim 3 wherein said mounting plate is pivotal and includes means for inhibiting pivotal movement of the mounting plate.

5. The combination of claim 3 wherein said face sheet material has a vertical edge and said face sheet material is looped about said vertical edge and said looped face sheet material defines said second fixed end vane which is secured to said mounting plate.

6. The combination of claim 5 wherein said second fixed end vane is releasably secured to said mounting plate.

7. The combination of claim 5 wherein said first fixed end vane is secured to said face sheet material at a location intermediate said second fixed end vane and the closest main vane.

8. The combination of a primary end cap and a vertical blind having a headrail, a plurality of vertically suspended main vanes and first and second fixed end vanes, a control system for moving said main vanes along said headrail, a face sheet material interconnecting said main vanes and said first and second fixed end vanes, said face sheet material having a vertical edge, said second fixed end vane being connected to said face sheet material at said vertical edge, and a pivotal mounting system pivotally mounting said first fixed end vane at a location intermediate said second fixed end vane and the closest main vane.

9. The combination of a secondary end cap and a vertical blind having a headrail, a plurality of vertically suspended main vanes and first and second movable end vanes, a control system for moving said main and movable end vanes along said headrail between extended and retracted positions, a face sheet material interconnecting said main vanes and said movable end vanes and having a vertical edge, said second movable end vane being secured to said face sheet material at said vertical edge, and a first pivotal mounting system pivotally mounting said first movable end vane at a location intermediate said second movable end vane and the closest main vane.

10. The combination of claim 9 further including a pivot arm operatively and pivotally connected to said closest main vane, said pivot arm adapted to move along said headrail in movement of said main vanes and movable end vanes between said extended and retracted positions and pivot around said secondary end cap in said extended position, and a pivot plate pivotally mounted on said pivot arm, said pivot plate pivotally supporting said first and second movable end vanes.

11. The combination of claim 10 wherein said pivotal mountings of said first and second movable end vanes is unbiased.

12. The combination of claim 11 wherein said face sheet material is looped about said vertical edge to define said second movable end vane and wherein said looped face sheet material is connected to said pivot plate.

13. The combination of claim 12 further including a mounting plate pivotally connected to said pivot plate and wherein said second movable end vane is connected to said mounting plate.

14. The combination of claim 13 wherein said second movable end vane is releasably connected to said mounting plate.

15. In a covering for an architectural opening wherein the covering includes a headrail with end caps, said headrail being mounted on but spaced from a support surface, a plurality of vertically oriented main vanes suspended from said headrail, a flexible face sheet material interconne4cting said main vanes, and a control system for moving said main vanes along the length of the headrail between extended and retracted positions of the covering and for pivoting the main vanes about vertical axes between open and closed positions, a method for covering at least one of said end caps and bridging the space between said headrail and the support surface comprising the steps of:
pivotally mounting on said at least one of said end caps a first and second vane and connecting said first and second vanes to said face sheet material, and
permitting said second vane to extend between said support surface and said at least one end cap on which it is pivotally mounted.

16. In the covering of claim 15 further including the step of:
establishing a vertical edge of said face sheet material adjacent to said at least one end cap, and
forming said second vane at said vertical edge.

17. In the covering of claim 16 further including the step of forming said first vane at a location along said face sheet material between said second vane and the nearest main vane.

18. In the covering of claim 15 further including the step of making said mounting of said first and second vanes to said at least one end cap freely pivotal.
